(19) United States
(12) Patent Application Publication
(10) Pub. No.: US 2017/0213170 A1
(43) Pub. Date: Jul. 27, 2017

(54) Competition Organization System and Method of Use

(71) Applicant: StockStat LP, Canyon, TX (US)

(72) Inventor: Rhett Bain, Canyon, TX (US)

(21) Appl. No.: 15/358,123

(22) Filed: Nov. 21, 2016

Related U.S. Application Data
(60) Provisional application No. 62/221,013, filed on Sep. 19, 2015.

(51) Int. Cl. G06Q 10/06; A63F 13/335; G06F 17/30; G06Q 30/00; G06Q 50/00

(52) U.S. Cl. CPC G06Q 10/06311; G06Q 10/06313; G06Q 30/018; G06Q 50/00; G06F 17/30; A63F 13/335

(57) ABSTRACT

A software system is disclosed. A one or more computers comprises a one or more input devices, an address space, a processor, a memory and a communication hardware. Said one or more computers comprises said software system. Said one or more computers comprises a first computer and a server. Said software system comprises a device application and a server application. Said server comprises said server application and a system database. Said first computer comprises said device application. Said system database comprises a plurality of user account records, a plurality of animal account records, a one or more event records, a one or more judging records, a plurality of animal competition records, a one or more competition records, a one or more registrant records and an event summary records. Said plurality of user account records is configured to track a plurality of users of said software system.

### CROSS-REFERENCE TO RELATED APPLICATIONS

This application claims benefit to U.S. Patent Application No. 62/221,013 filed on Sep. 19, 2015.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The software system disclosed herein comprises capabilities and features not seen in the prior art.

Prior art known to the Applicant includes US 20120265702 A1.

None of the known inventions and patents, taken either singularly or in combination, is seen to describe the instant disclosure as claimed.

### BRIEF SUMMARY OF THE INVENTION

A software system is disclosed. A one or more computers comprises a one or more input devices, an address space, a processor, a memory and a communication hardware. Said one or more computers comprises said software system. Said one or more computers comprises a first computer and a server. Said software system comprises a device application and a server application. Said server comprises said server application and a system database. Said first computer comprises said device application. Said system database comprises a plurality of user account records, a plurality of animal account records, a one or more event records, a one or more judging records, a plurality of animal competition records, a one or more competition records, a one or more registrant records and an event summary records. Said plurality of user account records is configured to track a plurality of users of said software system. Said plurality of user account records comprises a one or more competitors, a one or more administrators and a one or more judges. Said device application is configured to communicate with said server application on said server. Said server application comprises said plurality of user account records, said plurality of animal account records and said one or more event records. Said one or more event records comprise one or more records related to a one or more events. Said one or more event records comprises said plurality of animal competition records and said one or more registrant records. Said plurality of animal account records comprise one or more records related to a one or more animals tracked in said software system. Said one or more competition records each comprise a record of a competition as between a portion of said one or more animals at one among said one or more event records. Said one or more registrant records comprises said plurality of user account records and said plurality of animal account records. Said one or more registrant records comprise records of users and animals to compete at an event in a one or more competitions.

A software system is disclosed. A one or more computers comprises a one or more input devices, an address space, a processor, a memory and a communication hardware. Said one or more computers comprises said software system. A system database comprises a plurality of user account records, a plurality of animal account records, a one or more event records, a one or more judging records, a plurality of animal competition records, a one or more competition records, a one or more registrant records and an event summary records. Said plurality of user account records comprises a one or more competitors, a one or more administrators and a one or more judges. A server application comprises said plurality of user account records, said plurality of animal account records and said one or more event records. Said one or more event records comprise one or more records related to a one or more events. Said plurality of animal account records comprise one or more records related to a one or more animals tracked in said software system. Said plurality of user account records is configured to track a plurality of users of said software system. Said one or more event records comprises said plurality of animal competition records and said one or more registrant records. Said one or more registrant records comprise records of users and animals to compete at an event in a one or more competitions.

A software system is disclosed. A check-in procedure scanning a animal sheet with said device application retrieving a portion of said plurality of user account records related to a first animal retrieving a portion of a competition list related to said first animal and checking in said first animal for a competition. A one or more computers comprises a one or more input devices, an address space, a processor, a memory and a communication hardware. Said one or more computers comprises said software system. A system database comprises a plurality of user account records, a plurality of animal account records, a one or more event records, a one or more judging records, a plurality of animal competition records, a one or more competition records, a one or more registrant records and an event summary records. Said plurality of user account records comprises a one or more competitors, a one or more administrators and a one or more judges. A server application comprises said plurality of user account records, said plurality of animal account records and said one or more event records. Said one or more event records comprise one or more records related to a one or more events. Said plurality of animal account records comprise one or more records related to a one or more animals tracked in said software system. Said plurality of user account records is configured to track a plurality of users of said software system. Said one or more event records comprises said plurality of animal competition records and said one or more registrant records. Said one or more registrant records comprise records of users and animals to compete at an event in a one or more competitions.

### BRIEF DESCRIPTION OF THE SEVERAL VIEWS OF THE DRAWING

FIG. 1A illustrates a flow chart view of an users diagram 118.

FIG. 1D illustrates view of a network diagram 100.

FIG. 2A illustrates a perspective overview view of a mobile phone 201a.

FIG. 2B illustrates a perspective overview view of a personal computer 201b.

FIG. 2C illustrates a perspective overview view of a tablet 201c.

FIG. 3A illustrates view of an address space 302.

FIG. 3B illustrates view of an address space 302a.

FIG. 3C illustrates view of an address space 302d.

FIG. 4A illustrates a first embodiments for collecting and storing data view of an address space 302d.

FIG. 4B illustrates second embodiment for collecting and storing data view of an address space 302d.

FIG. 5A illustrates a flow chart view of a data storage 110.

FIG. 5B illustrates a flow chart view of a data storage 110a.

FIG. 6 illustrates a flow chart view of a competitors and animalsb view 600.

FIG. 7 illustrates a relationship view of a system database 720.

FIG. 8 illustrates a UI view of a system UI 800.

FIG. 9 illustrates table view of an user table 700.

FIG. 10 illustrates table view of an Animals Table 706.

FIG. 11 illustrates table view of a Judges Notes Table 708.

FIG. 12 illustrates table view of an Animal Notes Table 710.

FIG. 13 illustrates a UI view of an user profile tab 804.

FIG. 14 illustrates a UI view of a my animals tab 806.

FIG. 15 illustrates view of an upcoming events tab 808.

FIG. 16 illustrates a UI view of a competitions history tab 810.

FIG. 17 illustrates a UI view of a judges notes UI 1700.

FIG. 18 illustrates a UI view of a judge view of competitions 1800.

FIG. 19 illustrates a UI view of an event summary UI 1900.

FIG. 20 illustrates a flow chart view of a flow chart 2000.

FIG. 21 illustrates a flow chart view of a flow chart 2100.

FIG. 22 illustrates user overview view of an animal sheet view 2200.

FIG. 23 illustrates a flow chart view of a check-in procedure 2300.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

These parts are illustrated in the figures and discussed below:
a network diagram 100
a software system 101
a one or more computers 102
a first computer 102a
a second computer 102b
a third computer 102c
a one or more locations 103
a first location 103a
a second location 103b
a third location 103c
a printer 104
a network 106
a server 108
a data storage 110
a data storage 110a
an users diagram 118
a competition location 120
an administrative location 122
an animal location 124
an owner location 126
a one or more competitors 128
a first competitor 128a
a second competitor 128b
a third competitor 128c
a fourth competitor 128d
a fifth competitor 128e
a one or more animals 130
a first animal 130a
a second animal 130b
a third animal 130c
a fourth animal 130d
a fifth animal 130e
a one or more administrators 132
a one or more judges 134
a speaker 140
a plurality of users 142
a mobile phone 201a
a personal computer 201b
a tablet 201c
a screen 202
a one or more input devices 204
a keyboard 204a
a trackball 204b
a one or more cameras 204c
a track pad 204d
a data 206
a home button 220
an address space 302
an address space 302a
an address space 302b
an address space 302c
an address space 302d
a processor 304
a processor 304a
a processor 304b
a processor 304c
a processor 304d
a memory 306
a memory 306a
a memory 306b
a memory 306c
a memory 306d
a communication hardware 308
a communication hardware 308a
a communication hardware 308b
a communication hardware 308c
a communication hardware 308d
a device application 502
a data records 504a
a data records 504b
a data records 504c
a data records 504d
a server application 506
a competitors and animalsb view 600
an user table 700
an User ID 700a
an User Name 700b
an User Info 700c
a Date Created 700d
an User Email 700e
an Active 700f
a Location 700g
a Profile Pic 700h
an Events Table 702
an Event ID 702a
an Event Desc 702b
an Event Location 702c
an Event Start Date 702d
an Event End Date 702e
an Administrators List 702f
a Completed 702g
an Event Info 702h
a Registrants List 702k
an Event Registrants Table 703
a Registrant ID 703a
an Event Cross Reference 703b
an User Cross Reference 703c
a Registration Info 703d
an Event Competition Table 704
a Competition ID 704a
an Event Cross Reference 704b
an Event Date Sequence 704c
a Comp Date 704d
a Location 704e
an Animal Class 704f
an Animal Subclass 704g
a Competition Description 704h
a Judge List 704k
an Animals in Competition List 704m
an Animals Table 706
an Animal ID 706a
a Class 706b
a Subclass 706c
an Animal Name 706d
a DOB 706e
a Current Owner 706f
a Profile Image 706g
a Current Weight 706h
a Judges Notes Table 708
a Note ID 708a
a Competition Cross Reference 708b
an Animal Cross Reference 708c
a Rank 708d
a Judges Note 708e
an Animal Notes Table 710
an ID 710a
an Animal Reference 710b
a Date of Weigh In 710c
a Weight 710d
an Event Image 710e
a Notes 710f
a system database 720
a system UI 800
an announcements and alerts tab 802
an user profile tab 804
a my animals tab 806
an upcoming events tab 808
a competitions history tab 810
a plurality of tabs 812
a one or more announcements 820
a first announcement 820a
a second announcement 820b
a plurality of user account records 902
a plurality of animal account records 1002
a one or more judging notes 1102
a one or more animal note records 1202
a one or more event records 1502
a judges notes UI 1700
a one or more judging records 1702
a plurality of event rankings 1704
a judge view of competitions 1800
a competition list 1802
a plurality of animal competition records 1804
a competition details 1806
an event summary UI 1900
a one or more competition records 1902
a one or more registrant records 1904
an event summary records 1906
a flow chart 2000
a first step 2002
a second step 2004
a third step 2006
a fourth step 2008a
a fourth step 2008b
a fifth step 2010
a flow chart 2100
a first step 2102
a second step 2104
a third step 2106
a fourth step 2108
a fifth step 2110
a sixth step 2112
a seventh step 2114
an eighth step 2116
a close procedure step 2118
an animal sheet view 2200
an animal sheet 2202
a check-in procedure 2300
a first step 2302
a second step 2304
a third step 2306
a fourth step 2308
a close procedure step 2310
a current competition 2312

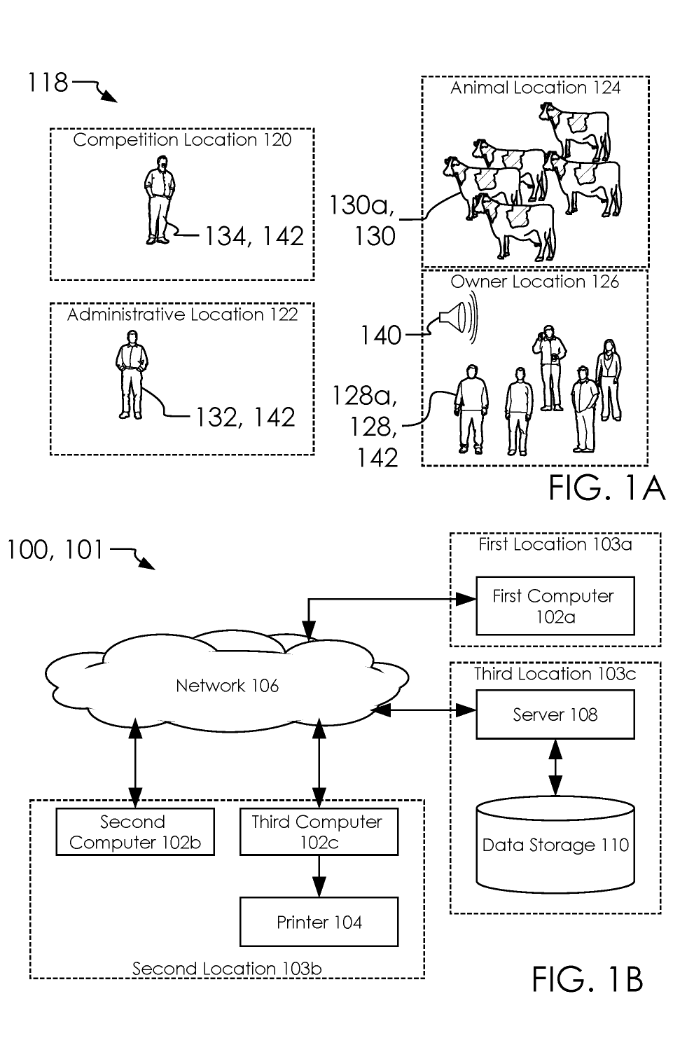

FIG. 1A illustrates a flow chart view of an users diagram 118.

FIG. 1D illustrates view of a network diagram 100.

In one embodiment, said network diagram 100 can comprise said software system 101, said one or more computers 102, said one or more locations 103, said printer 104, said network 106, said server 108 and said data storage 110.

In one embodiment, said one or more computers 102 can comprise said first computer 102a, said second computer 102b and said third computer 102c.

In one embodiment, said one or more locations 103 can comprise said first location 103a, said second location 103b and said third location 103c.

In one embodiment, said data storage 110 can comprise said data storage 110a.

In one embodiment, said competition location 120 can comprise said one or more judges 134.

In one embodiment, said users diagram 118 can comprise said competition location 120, said administrative location 122, said animal location 124 and said owner location 126.

In one embodiment, said administrative location 122 can comprise said one or more administrators 132.

In one embodiment, said animal location 124 can comprise said one or more animals 130.

In one embodiment, said owner location 126 can comprise said one or more competitors 128 and said speaker 140.

In one embodiment, said one or more competitors 128 can comprise said first competitor 128a, said second competitor 128b, said third competitor 128c, said fourth competitor 128d and said fifth competitor 128e.

In one embodiment, said one or more animals 130 can comprise said first animal 130a, said second animal 130b, said third animal 130c, said fourth animal 130d and said fifth animal 130e.

In one embodiment, said plurality of users 142 can comprise said one or more competitors 128, said one or more administrators 132 and said one or more judges 134.

In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

In one embodiment, said users diagram 118 can comprise a competition location 120, an administrative location 122, an animal location 124, an owner location 126, a judge 134, an administrator 132, a one or more animals 130 (which can comprise a first animal 130a), a one or more competitors 128 (which can comprise a first competitor 128a), and a speaker system 140.

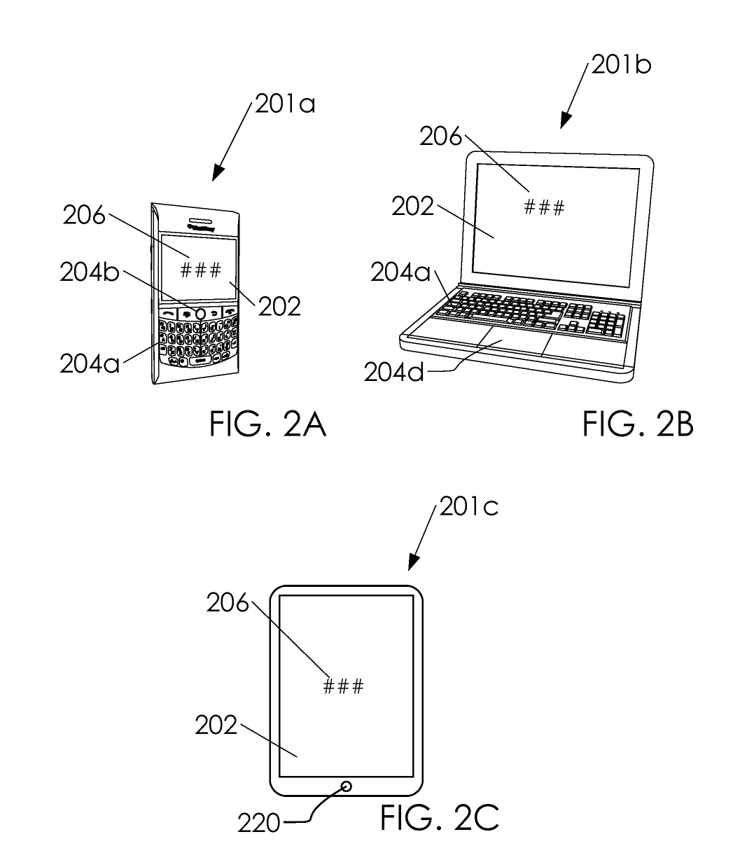

FIG. 2A illustrates a perspective overview view of a mobile phone 201a.

FIG. 2B illustrates a perspective overview view of a personal computer 201b.

FIG. 2C illustrates a perspective overview view of a tablet 201c.

In one embodiment, said tablet 201c can comprise said screen 202, said one or more input devices 204, said one or more cameras 204c, said data 206 and said home button 220.

In one embodiment, said personal computer 201b can comprise said screen 202, said one or more input devices 204, said keyboard 204a, said track pad 204d and said data 206.

In one embodiment, said mobile phone 201a can comprise said screen 202, said one or more input devices 204, said keyboard 204a, said trackball 204b and said data 206.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said tablet 201c and/or said personal computer 201b can comprise a Microsoft® Windows® branded device, an Apple® branded device, or similar. In one embodiment, said tablet 201c can be an X86 type processor or an ARM type processor, as is known in the art.

Said network diagram 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices like said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar

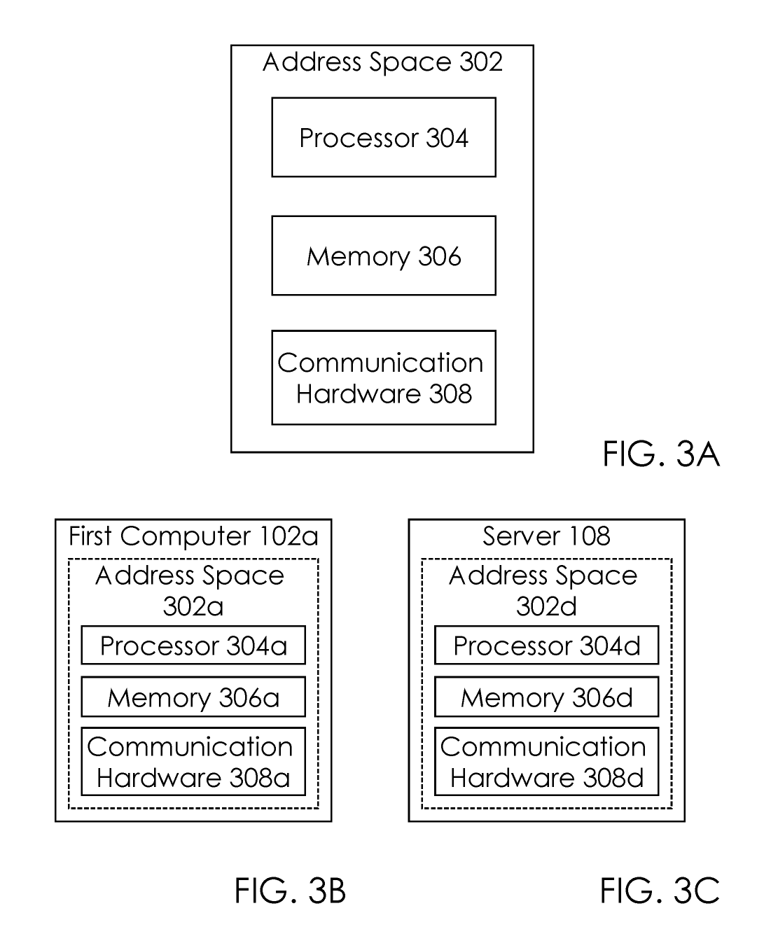

FIG. 3A illustrates view of an address space 302.

FIG. 3B illustrates view of an address space 302a.

FIG. 3C illustrates view of an address space 302d.

In one embodiment, said address space 302 can comprise said processor 304, said memory 306 and said communication hardware 308.

In one embodiment, said address space 302a can comprise said processor 304a, said memory 306a and said communication hardware 308a.

In one embodiment, said address space 302b can comprise said processor 304b, said memory 306b and said communication hardware 308b.

In one embodiment, said address space 302c can comprise said processor 304c, said memory 306c and said communication hardware 308c.

In one embodiment, said address space 302d can comprise said processor 304d, said memory 306d and said communication hardware 308d.

In one embodiment, said one or more computers 102 can comprise said address space 302.

In one embodiment, said first computer 102a can comprise said address space 302a.

In one embodiment, said second computer 102b can comprise said address space 302b.

In one embodiment, said third computer 102c can comprise said address space 302c.

In one embodiment, said server 108 can comprise said address space 302d.

Each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

In one embodiment, said first computer 102a can comprise said address space 302a, a processor 304a, a memory 306a, and a communication hardware 308a. Likewise, in one embodiment, said server 108 can comprise said address space 302d, a processor 304d, a memory 306d, and a communication hardware 308d.

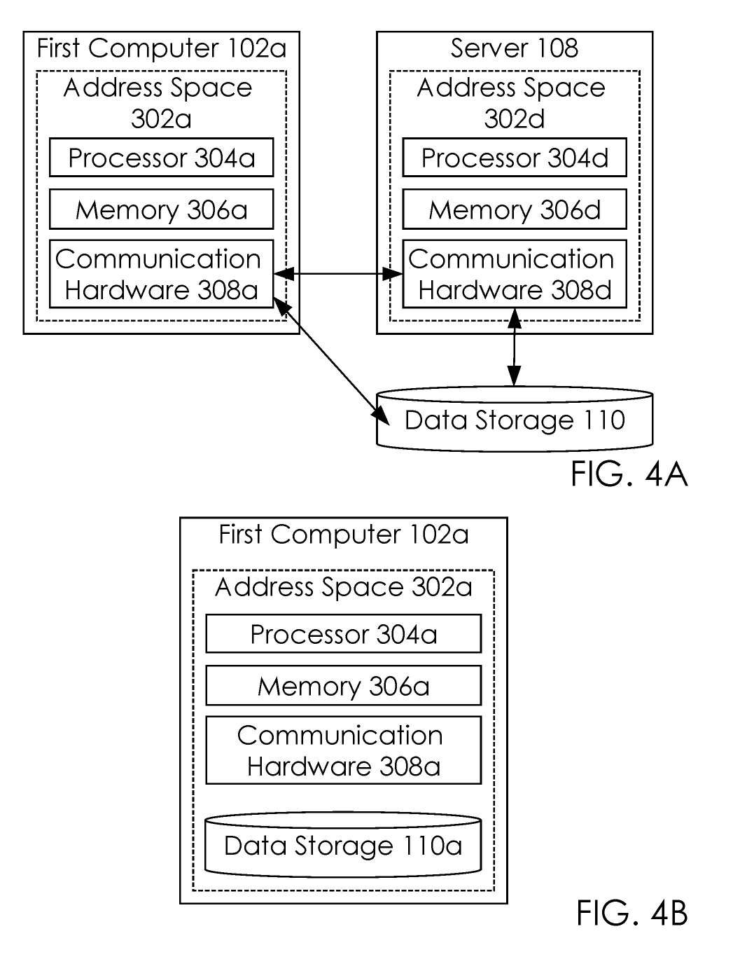

FIG. 4A illustrates a first embodiments for collecting and storing data view of an address space 302d.

FIG. 4B illustrates second embodiment for collecting and storing data view of an address space 302d.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said network diagram 100. In another embodiment, said data can be stored temporarily on said data storage 110a and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110a. Thus, said first computer 102a can operate without a data connection out to said server 108 while performing said system and method for field capture of data.

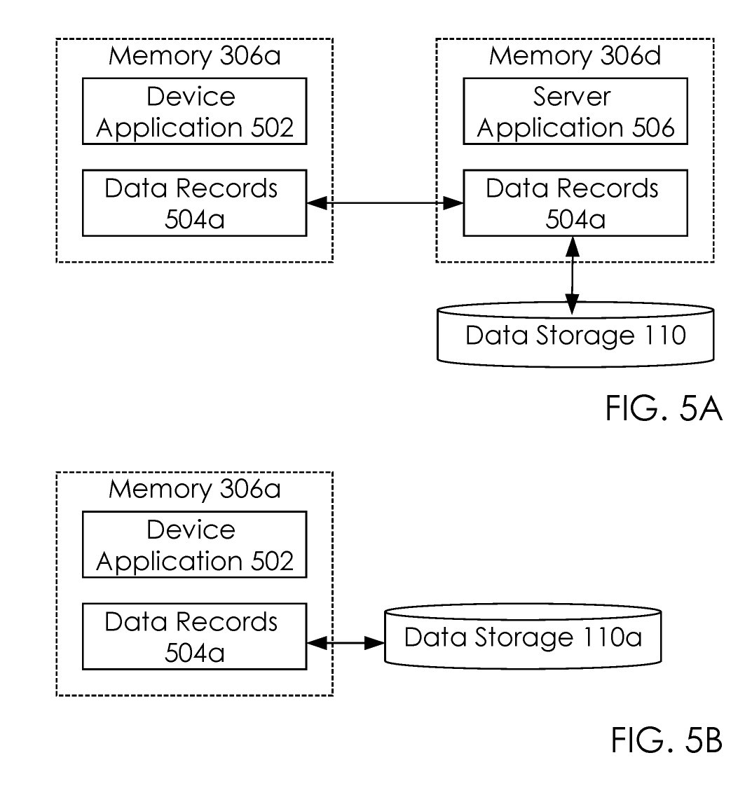

FIG. 5A illustrates a flow chart view of a data storage 110.

FIG. 5B illustrates a flow chart view of a data storage 110a.

In one embodiment, said memory 306a can comprise said device application 502 and said data records 504a.

In one embodiment, said memory 306d can comprise said data records 504a and said server application 506.

In one embodiment, said software system 101 can comprise said device application 502 and said server application 506.

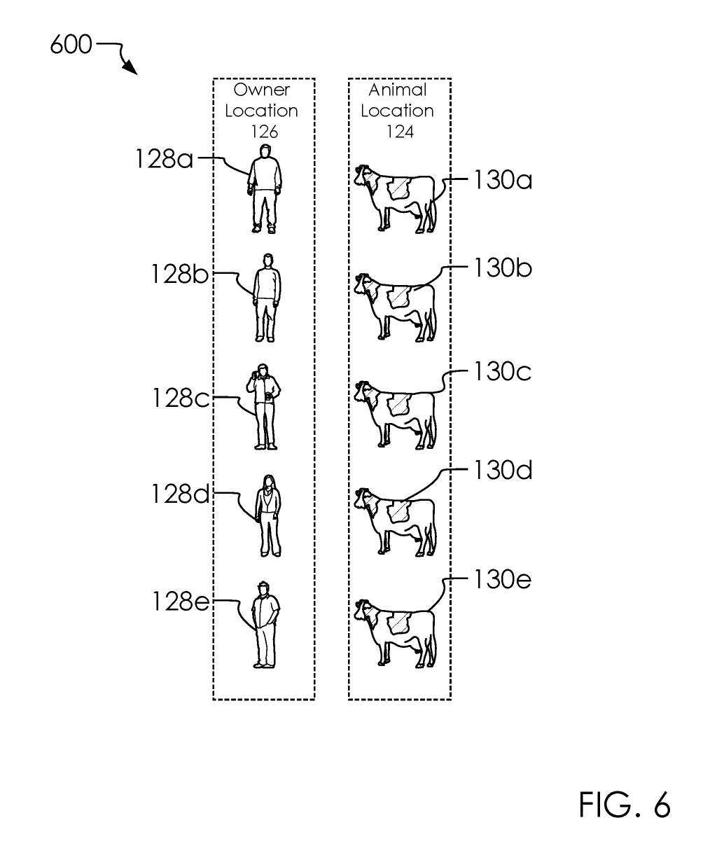

FIG. 6 illustrates a flow chart view of a competitors and animalsb view 600.

In one embodiment, said competitors and animals view 600 can describe a functional advantage of said

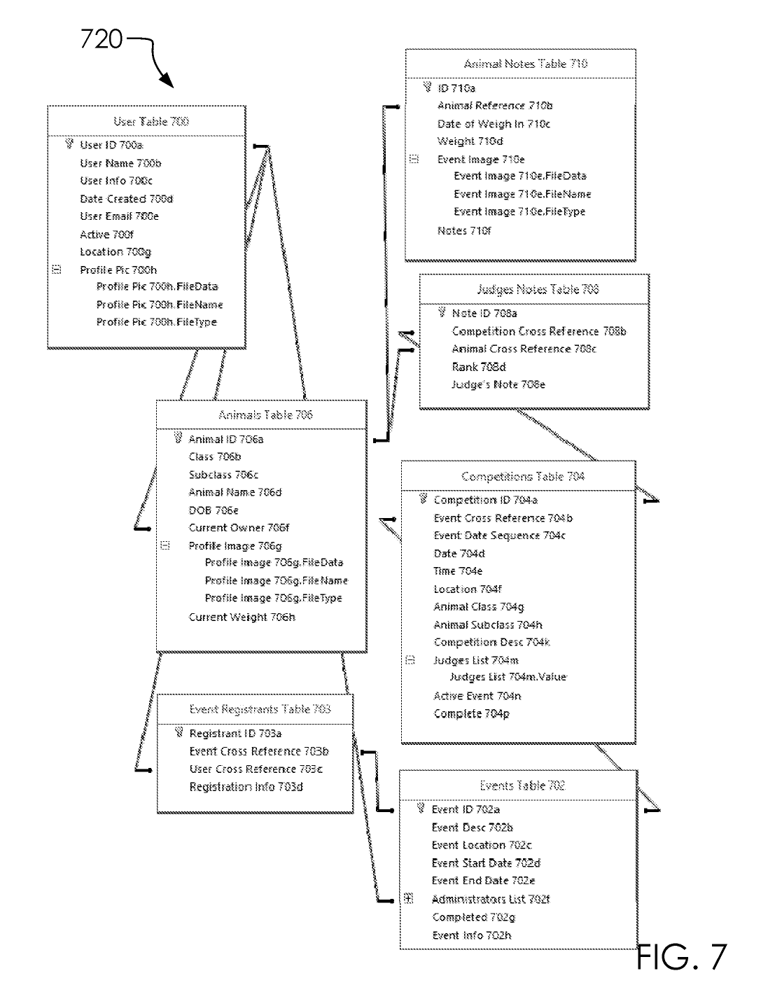

FIG. 7 illustrates a relationship view of a system database 720.

In one embodiment, said user table 700 can comprise said User ID 700a, said User Name 700b, said User Info 700c, said Date Created 700d, said User Email 700e, said Active 700f, said Location 700g and said Profile Pic 700h.

In one embodiment, said Events Table 702 can comprise said Event ID 702a, said Event Desc 702b, said Event Location 702c, said Event Start Date 702d, said Event End Date 702e, said Administrators List 702f, said Completed 702g, said Event Info 702h and said Registrants List 702k.

In one embodiment, said Event Competition Table 704 can comprise said Competition ID 704a, said Event Cross Reference 704b, said Event Date Sequence 704c, said Comp Date 704d, said Location 704e, said Animal Class 704f, said Animal Subclass 704g, said Competition Description 704h, said Judge List 704k and said Animals in Competition List 704m.

In one embodiment, said Animals Table 706 can comprise said Animal ID 706a, said Class 706b, said Subclass 706c, said Animal Name 706d, said DOB 706e, said Current Owner 706f, said Profile Image 706g and said Current Weight 706h.

In one embodiment, said Judges Notes Table 708 can comprise said Note ID 708a, said Competition Cross Reference 708b, said Animal Cross Reference 708c, said Rank 708d and said Judges Note 708e.

In one embodiment, said Animal Notes Table 710 can comprise said ID 710a, said Animal Reference 710b, said Date of Weigh In 710c, said Weight 710d, said Event Image 710e and said Notes 710f.

In one embodiment, said system database 720 can comprise said user table 700, said Events Table 702, said Event Competition Table 704, said Animals Table 706, said Judges Notes Table 708 and said Animal Notes Table 710.

In one embodiment, said Event Registrants Table 703 can comprise said Registrant ID 703a, said Event Cross Reference 703b, said User Cross Reference 703c and said Registration Info 703d.

In one embodiment, said each of the tables for said system database 720 can comprise a plurality of records as illustrated.

Said user table 700 can comprise a one or more records related to users of said software system 101. Said Events Table 702 can comprise a one or more records related to a one or more events to be conducted or previously conducted. User records in said user table 700 can be listed in a plurality of said Events Table 702, as is known in the art.

Said Event Registrants Table 703 can comprise a registration record of users from said user table 700 to attend one or more among said Events Table 702, as is known in the art.

Said Event Competition Table 704 can comprise a one or more competitions to be conducted at said Events Table 702. In one embodiment, a plurality of said Event Competition Table 704 can be related to one or more among said Events Table 702. Thus, said Events Table 702 can comprise a one to many relationship with said Event Competition Table 704.

Said Animals Table 706 can comprise a one or more records related to animals to participate in a one or more events and competitions. Each animal in said Animals Table 706 can comprise an owner in said user table 700 as linked with said Current Owner 706f.

Said Judges Notes Table 708 can comprise a list of notes collected by users in said user table 700 who work as judges at events and competitions. Accordingly, a judge might rank each animal in a competition as 1st, 2nd, 3rd, and so on by altering said Rank 708d with reference to a particular animal (lined by said Animal Cross Reference 708c).

Said Animal Notes Table 710 can comprise a one or more records related to said Animals Table 706. In one embodiment, said Animals Table 706 can comprise a one to many relationship with said Animal Notes Table 710 wherein said Animal Notes Table 710 may have a plurality of records for each record in said Animals Table 706.

As illustrated, said system database 720 can comprise a implication of the relationships in said software system 101. Further, illustrations include English friendly table and record names. This may not be advantageous in professional development environments depending on local nomenclature. Likewise, many fields are simplifications of more complex data structures such as Registration Info 702k which compresses possibly hundreds of fields into one field for the purposes of simplifying this disclosure. A person of reasonable ability in this art group would understand that “info” fields and fields omitted entirely are implicitly included in said system database 720.

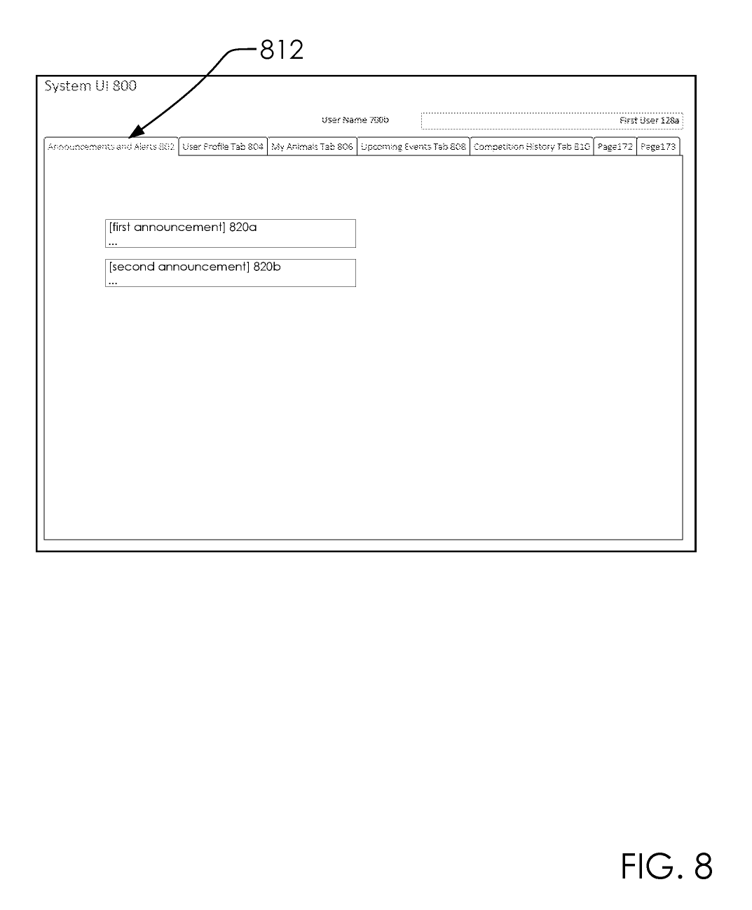

FIG. 8 illustrates a UI view of a system UI 800.

In one embodiment, said system UI 800 can comprise said plurality of tabs 812.

In one embodiment, said announcements and alerts tab 802 can comprise said one or more announcements 820.

In one embodiment, said plurality of tabs 812 can comprise said announcements and alerts tab 802, said user profile tab 804, said my animals tab 806, said upcoming events tab 808 and said competitions history tab 810.

In one embodiment, said one or more announcements 820 can comprise said first announcement 820a and said second announcement 820b.

In one embodiment, said device application 502 can comprise said system UI 800.

Said plurality of tabs 812 can comprise other tabs, illustrated here as “Page172” and “Page 178” which have been left as place holders for future tab entry.

Said system UI 800 can comprise a rough approximation of said device application 502 for illustrative purposes.

Said device application 502 can be navigated with said plurality of tabs 812.

Said announcements and alerts tab 802 can comprise said one or more announcements 820. Said one or more announcements 820 can comprise notices related to a particular user of said software system 101. For example, said one or more competitors 128 can receive notices of upcoming and relevant competitions; said one or more judges 134 can receive notices of upcoming events and requests by said one or more administrators 132; and said one or more administrators 132 can receive any and all notices.

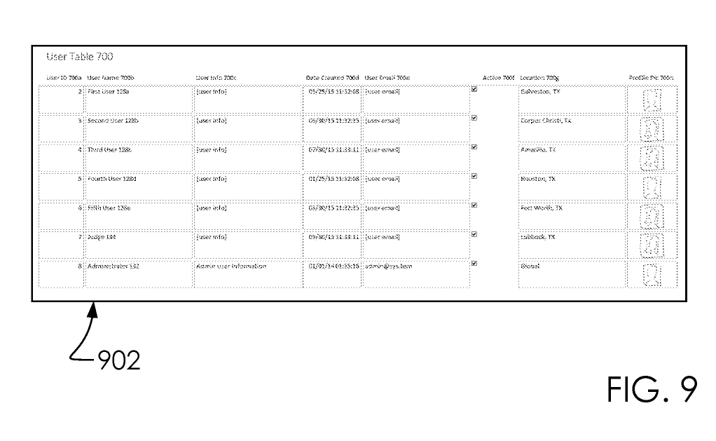

FIG. 9 illustrates table view of an user table 700.

Said user table 700 can comprise records related to said plurality of user account records 902.

Said User ID 700a can comprise a unique ID of each record herein. Said 70b/can comprise a user name; said User Info 700c can comprise a field summarizing a one or more fields well-known in the art; said Date Created 700d can comprise a date a record was created; s aid User Email 700e can comprise an email address; said Active 700f can comprise a flag as to whether a user is active in the system; said Location 700g can comprise a location of a user; and said Profile Pic 700h can comprise an image of a user.

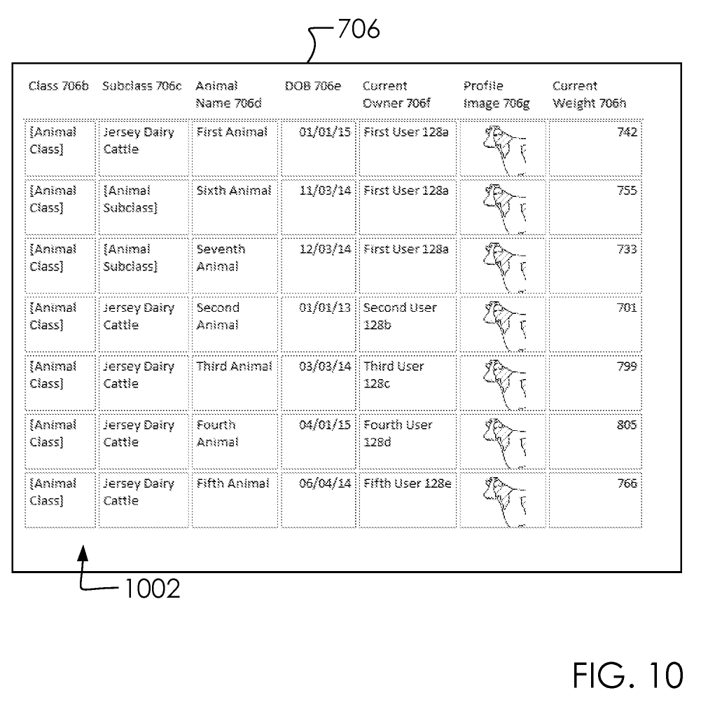

FIG. 10 illustrates table view of an Animals Table 706.

Said Animals Table 706 can comprise said plurality of animal account records 1002. Said plurality of animal account records 1002 can comprise said Animal ID 706a (not illustrated here) as a unique ID; said Class 706b can comprise a class of animal; said Subclass 706c can comprise a subclass; said Animal Name 706d can comprise a name of an animal; said DOB 706e can comprise a data an animal was born; said Current Owner 706f can comprise a reference to said user table 700 to identify an owner of an animal; said Profile Image 706g can comprise an image of an animal; and said Current Weight 706h can comprise a current weight of an animal.

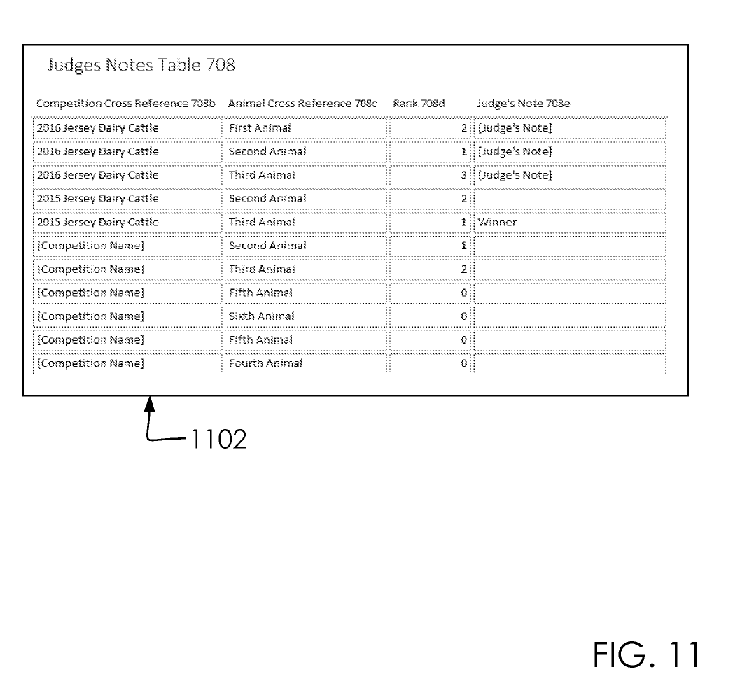

FIG. 11 illustrates table view of a Judges Notes Table 708.

Said Judges Notes Table 708 can comprise said one or more judging notes 1102 comprising: said Note ID 708a (not illustrated here) as a unique ID; said Competition Cross Reference 708b can comprise a cross reference to a competition record; said Animal Cross Reference 708c can comprise a reference to an animal in said Animals Table 706; said Rank 708d can comprise a rank of the animal in said Animal Cross Reference 708c for the competition identified in said Competition Cross Reference 708b; and finally, said Judges Note 708e can comprise a note entered by a judge during said Competition Cross Reference 708b.

as illustrated, some notes in said Judges Notes Table 708 can be entered without a number, or else a zero number, in said Rank 708d to indicate the competition has not been conducted or will be conducted in the future. Said Judges Note 708e can be optional.

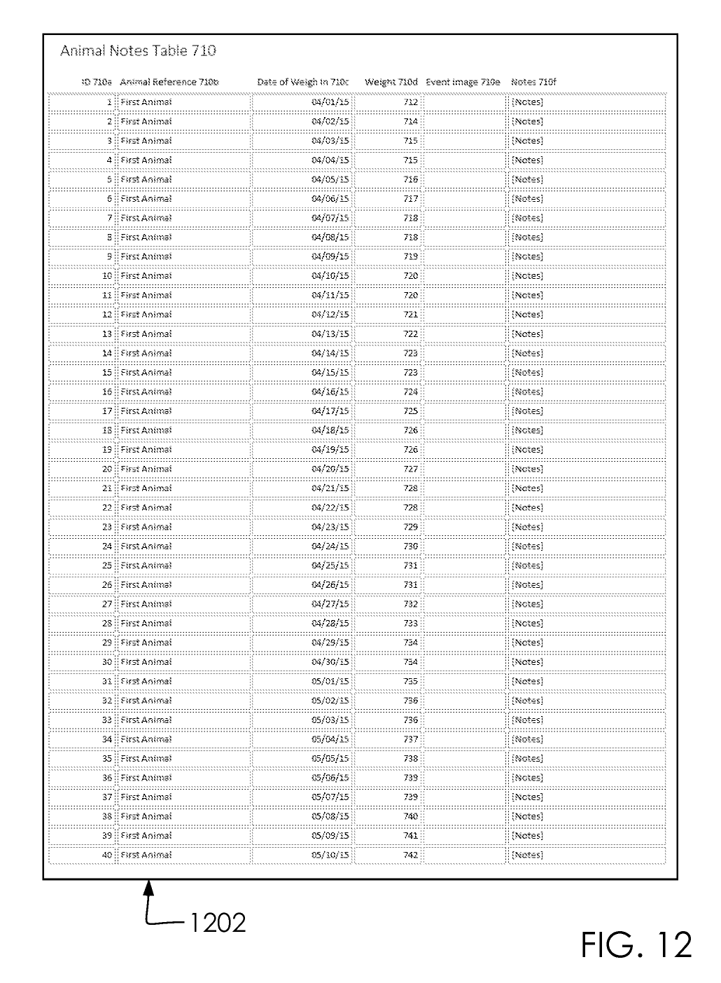

FIG. 12 illustrates table view of an Animal Notes Table 710.

Said Animal Notes Table 710 can comprise said one or more animal note records 1202 comprising: said ID 710a as a unique ID, said Animal Reference 710b as a reference to an animal in said Animals Table 706; said Date of Weigh In 710c as a date of a record entry; said Weight 710d can comprise a weight of said Animal Reference 710b on said Date of Weigh In 710c; said Event Image 710e can comprise an image of said Animal Reference 710b on said Date of Weigh In 710c; and said Notes 710f can comprise an additional entry on said Date of Weigh In 710c for said Animal Reference 710b.

Said Weight 710d, said Event Image 710e and said Notes 710f can be optional.

Said Notes 710f can comprise a text or mixed media type entry field. Said Event Image 710e can comprise a plurality of images, videos, or similar data, as is known in the art.

Said Date of Weigh In 710c can comprise a date and time record.

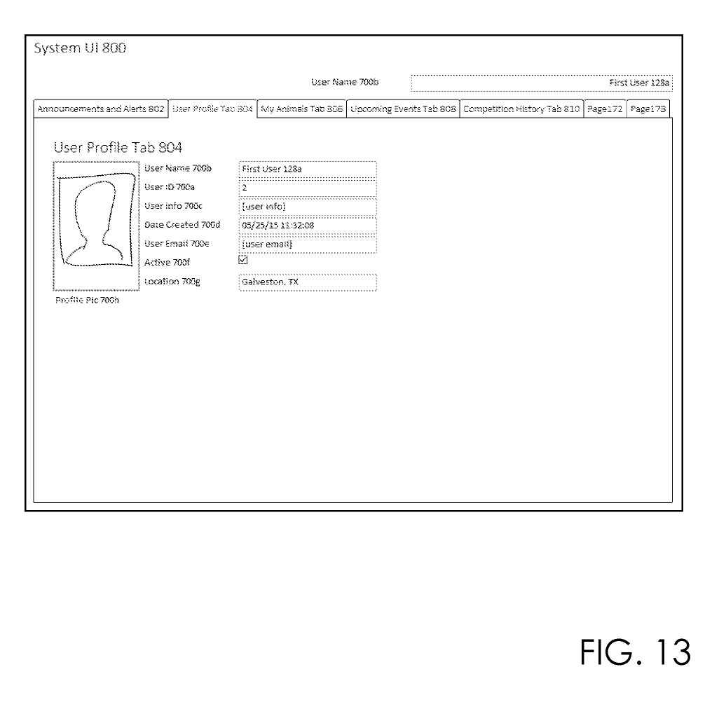

FIG. 13 illustrates a UI view of an user profile tab 804.

Said user profile tab 804 can comprise data from said user table 700 as well as other user profile information, as is known in the art.

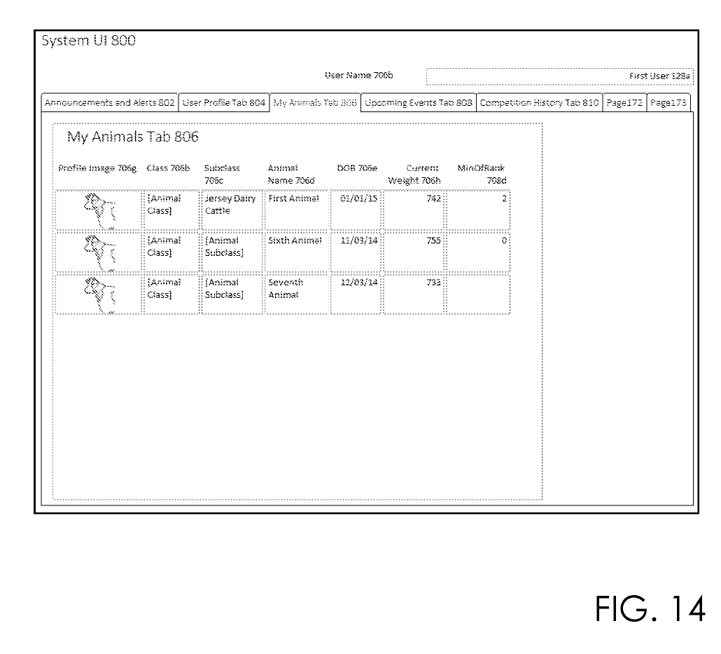

FIG. 14 illustrates a UI view of a my animals tab 806.

Said my animals tab 806 can comprise can comprise a portion of said Animals Table 706. In one embodiment, said my animals tab 806 can show only those among said plurality of animal account records 1002 being owned by a user logged into said device application 502 (here said first competitor 128a, for example).

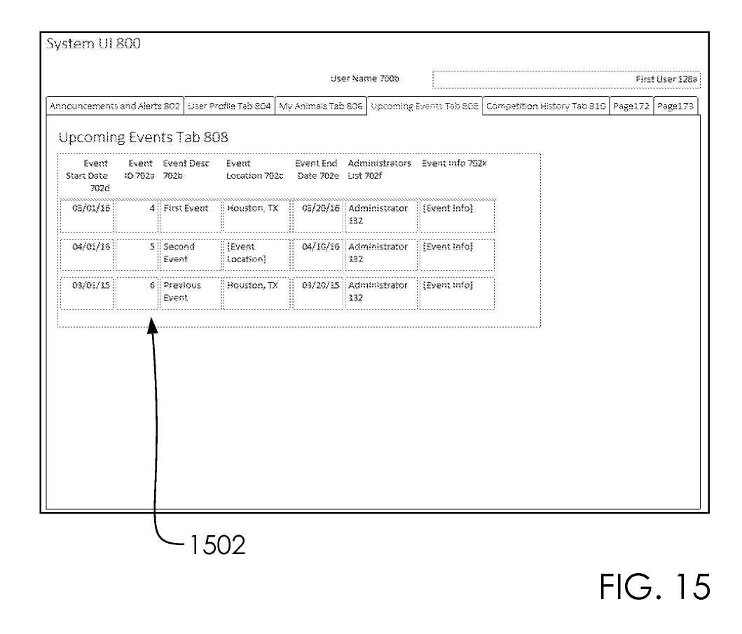

FIG. 15 illustrates view of an upcoming events tab 808.

In one embodiment, said Events Table 702 can comprise said one or more event records 1502.

In one embodiment, said upcoming events tab 808 can comprise a portion of said Events Table 702.

Said Events Table 702 can comprise said one or more event records 1502 comprising: said Event ID 702a as a unique ID, said Event Disc 702b as a description; said Event Location 702c as a location; said Event Start Date 702d as a starting date and/or time; said Event End Date 702e as an ending date and/or time; said Administrators List 702f as a list of administrators from said user table 700 related to an event record in said Events Table 702; and said Registration Info 702k as info about an event.

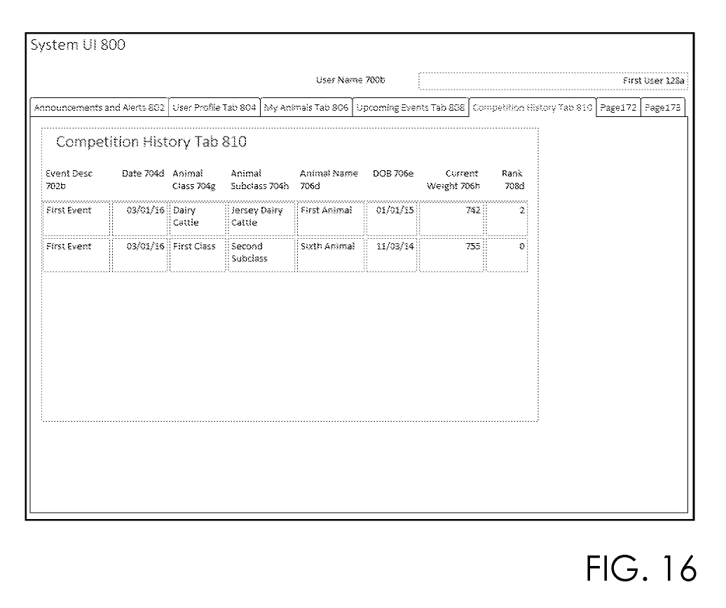

FIG. 16 illustrates a UI view of a competitions history tab 810.

Said competitions history tab 810 can comprise a portion of said Events Table 702, said Event Competition Table 704, said Animals Table 706 and said Judges Notes Table 708 which related to a current user of said software system 101 (here, said first competitor 128a).

Here, said competitions history tab 810 show two records for animals in two different events which related to said first competitor 128a.

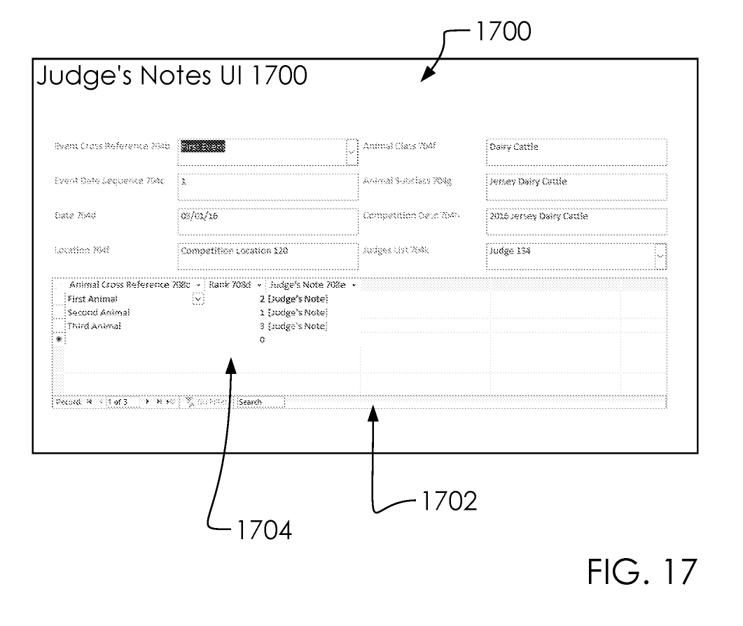

FIG. 17 illustrates a UI view of a judges notes UI 1700.

In one embodiment, said judges notes UI 1700 can be accessed by judges of events and competitions. Said judges notes UI 1700 can comprise records from said Event Competition Table 704, said one or more judging records 1702 and said plurality of event rankings 1704.

Said one or more judging records 1702 can comprise a portion of said Judges Notes Table 708 for a competition identified in said Event Competition Table 704. In one embodiment, said Event Competition Table 704 can comprise a one to many relationship with said Judges Notes Table 708. Accordingly, a plurality of said Judges Notes Table 708 can be displayed for each among said Event Competition Table 704, as illustrated.

In one embodiment, said plurality of event rankings 1704 can comprise judging results, as is known in the art.

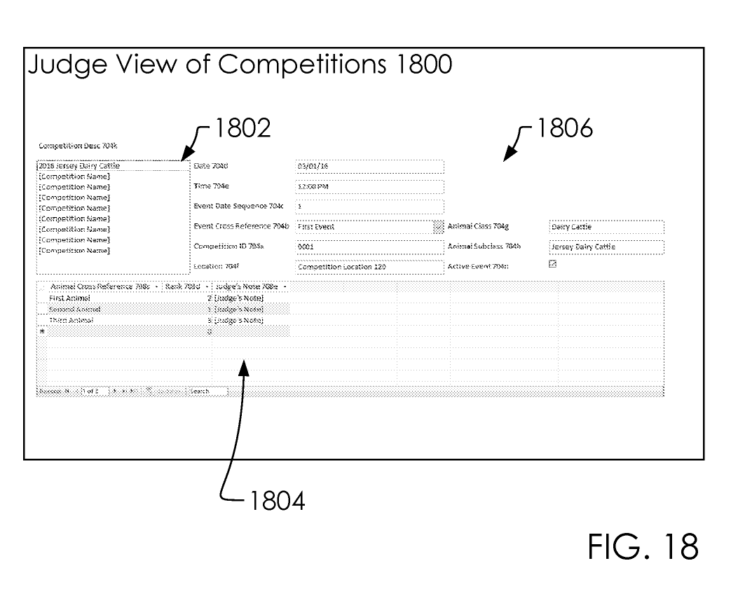

FIG. 18 illustrates a UI view of a judge view of competitions 1800.

In one embodiment, said judge view of competitions 1800 can comprise said competition list 1802, said plurality of animal competition records 1804 and said competition details 1806.

In one embodiment, said judge view of competitions 1800, like said judges notes UI 1700, can be accessed by said one or more judges 134.

Said judge view of competitions 1800 can comprise said competition list 1802, a portion of said competition details 1806 and a one or more among said Judges Notes Table 708. Said judge view of competitions 1800 can be distinguished from said judges notes UI 1700 by the addition of a navigational aid in said competition list 1802 for changing which among said competition details 1806 and said plurality of animal competition records 1804 are displayed.

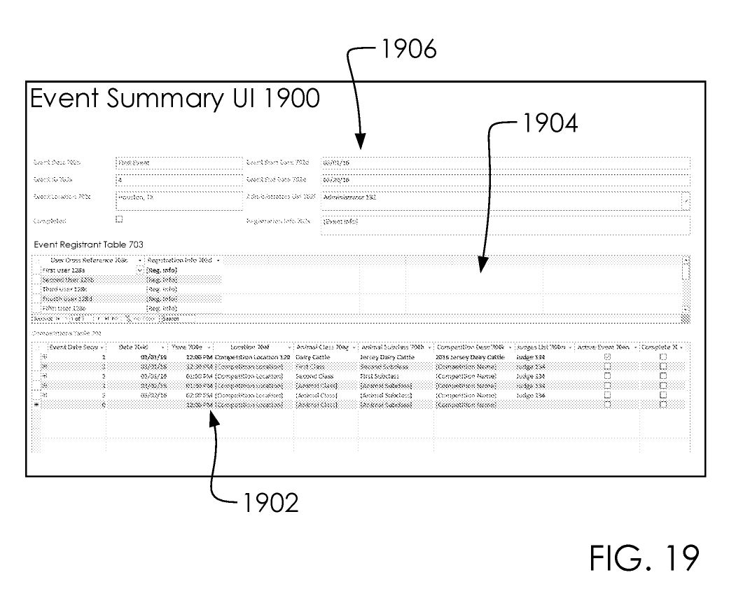

FIG. 19 illustrates a UI view of an event summary UI 1900.

In one embodiment, said event summary UI 1900 can comprise said one or more competition records 1902, said one or more registrant records 1904 and said event summary records 1906.

Said event summary UI 1900 can comprise a summary of one among said Events Table 702.

Said event summary UI 1900 can comprise said one or more competition records 1902, said one or more registrant records 1904 and said event summary records 1906. Said event summary records 1906 can comprise a portion of said Events Table 702 comprising a current record under consideration. Said one or more registrant records 1904 can comprise a one or more records from said Event Registrants Table 703 representing a one or more among said user table 700. Said Event Registrants Table 703 can comprise said one or more registrant records 1904 comprising: said Registrant ID 703a as a unique ID, said Event Cross Reference 703b as a reference to a record in said Events Table 702; said User Cross Reference 703c as a reference opt a record in said user table 700; and said Registration Info 703d comprising information related to a registration of a user for an event. Said Registration Info 703d can comprise one or more fields as is known in the art.

Said one or more registrant records 1904 can show all users registered for an event identified in said event summary records 1906.

Said one or more competition records 1902 can comprise a portion of said Event Competition Table 704, further representing a one or more competitions in a particular event.

Thus, said Events Table 702 can comprise a one to many relationship with said Event Registrants Table 703 and said Event Competition Table 704, as illustrated.

In one embodiment, said Event Competition Table 704 can comprise said one or more competition records 1902 comprising: said Competition ID 704a as a unique ID; said Event Cross Reference 704b as a reference to a record in said Events Table 702; said Event Date Sequence 704c as an integer representing an order of events on a particular day and/or location; said Comp Date 704d can comprise a date; said Location 704e can comprise a time; said Animal Class 704f can comprise a location; said Animal Subclass 704g and said Competition Description 704h can comprise classifications of animals in a competition; said 704k can comprise an English name for a competition; said Animals in Competition List 704m can comprise a list of judges to oversee a competition which represent a one or more references to users in said user table 700; said 704n/can comprise a flag as to whether an event is active or not; and said 704p can comprise a flat for whether an event is complete or not.

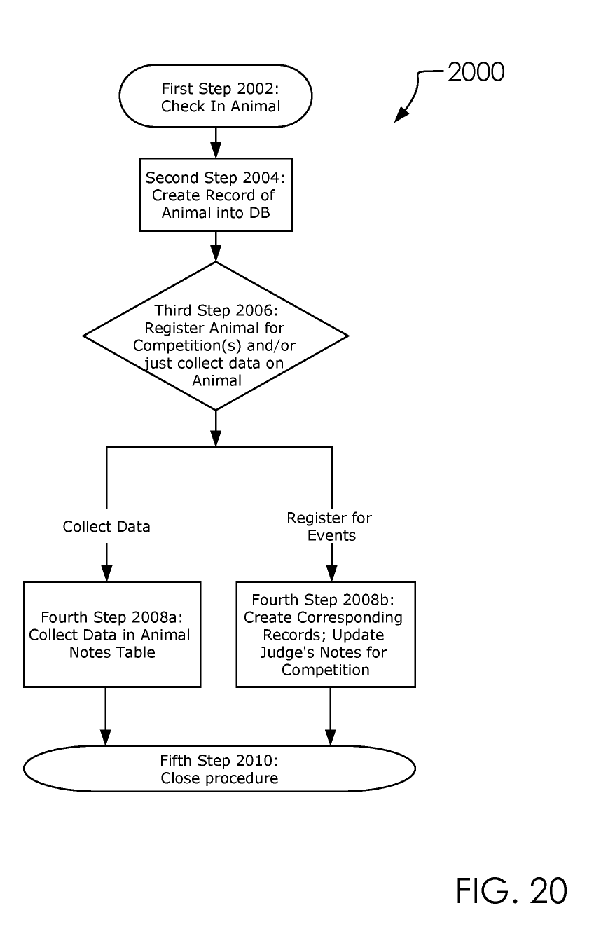

FIG. 20 illustrates a flow chart view of a flow chart 2000.

In one embodiment, said flow chart 2000 can comprise said first step 2002, said second step 2004, said third step 2006, said fourth step 2008a, said fourth step 2008b and said fifth step 2010.

Said flow chart 2000 can comprise: checking in an animal (said first step 2002); creating a record of an animal in a DB (said second step 2004); registering said animal for a one or more competitions and/or just collecting data on said animal (said third step 2006); either collecting data on that animal in a notes table (said fourth step 2008a) or creating corresponding records and updating judges notes for a competition (said fourth step 2008b); and finally, closing said flow chart 2000 (said fifth step 2010).

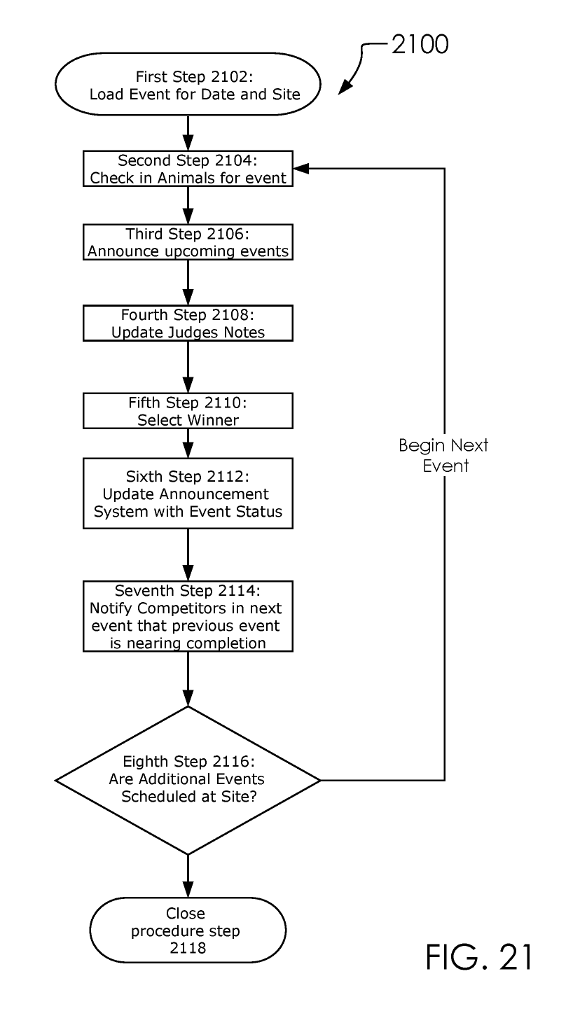

FIG. 21 illustrates a flow chart view of a flow chart 2100.

In one embodiment, said flow chart 2100 can comprise said first step 2102, said second step 2104, said third step 2106, said fourth step 2108, said fifth step 2110, said sixth step 2112, said seventh step 2114, said eighth step 2116 and said close procedure step 2118.

Said flow chart 2100 can comprise a flow chart of how an event or competition might be administered with the assistance of said software system 101.

For example, in one embodiment, said flow chart 2100 can comprise: loading event, data and site data into said software system 101 (said first step 2102); checking in animals for said events (said second step 2104); announcing upcoming events (said third step 2106); updating judges' notes (said fourth step 2108); selecting winners and losers (said fifth step 2110); updating announcements and event status (said sixth step 2112); notifying competitors in next event that the previous event is nearing completion (said seventh step 2114); determining if additional events are scheduled at a particular site (said eighth step 2116); and either closing said flow chart 2100 or looping back to said second step 2104.

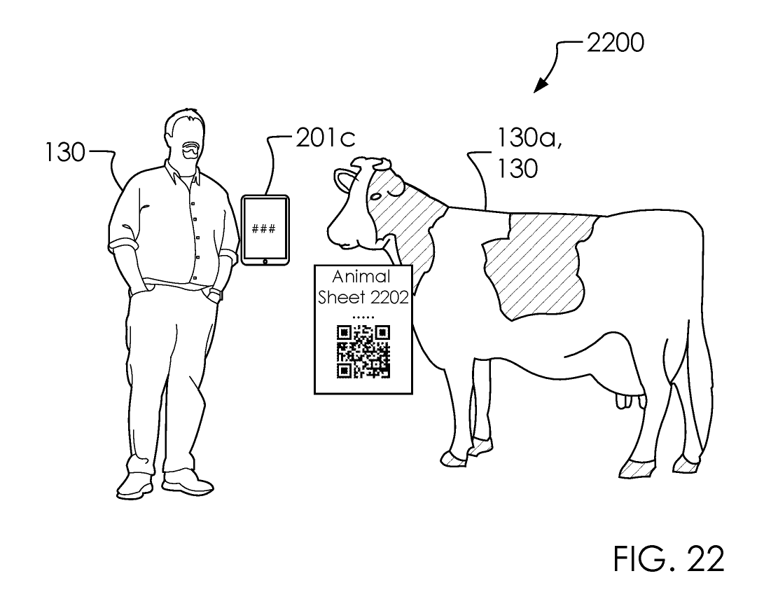

FIG. 22 illustrates user overview view of an animal sheet view 2200.

In one embodiment, said animal sheet 2202 can be used to check in an animal during a competition to simplify the work of a judge in need of cataloging their notes for an animal, as is known in the art.

One feature of said software system 101 can comprise using said one or more computers 102 for collecting data on said one or more animals 130, organizing said one or more event records 1502, keeping said plurality of animal competition records 1804 and said one or more competition records 1902, and tracking said one or more animal note records 1202 for said plurality of user account records 902.

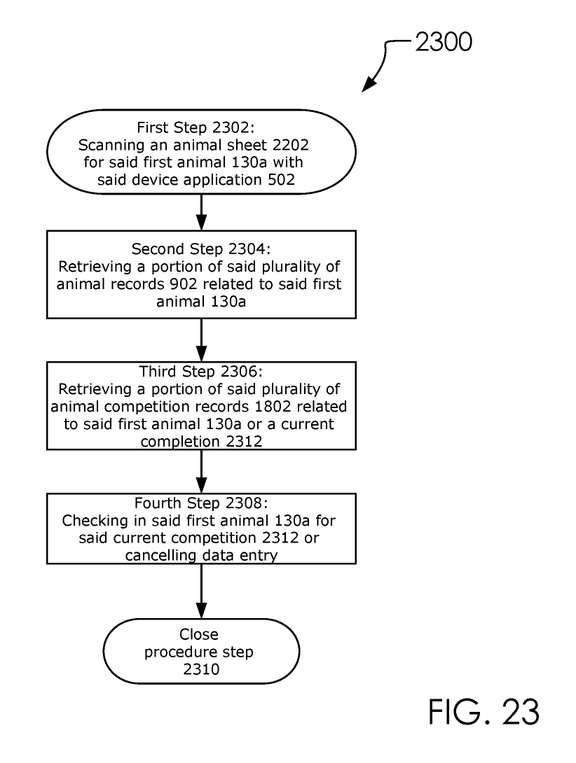

FIG. 23 illustrates a flow chart view of a check-in procedure 2300.

In one embodiment, said check-in procedure 2300 can comprise said first step 2302, said second step 2304, said third step 2306, said fourth step 2308 and said close procedure step 2310.

In one embodiment, said one or more competition records 1902 can comprise said current competition 2312.

Said first step 2302 can comprise scanning an animal sheet 2202 for said first animal 130a with said device application 502. Said second step 2304 can comprise retrieving a portion of said plurality of user account records 902 related to said first animal 130a. Said third step 2306 can comprise retrieving a portion of said plurality of said competition list 1802 related to said first animal 130a or said current competition 2312. Said fourth step 2308 can comprise checking in said first animal 130a for said current competition 2312 or cancelling data entry in said device application 502. Said close procedure step 2310 can comprise closing said check-in procedure 2300.

Said check-in procedure 2300 can comprise a procedure for checking in said one or more animals 130 as illustrated in FIG. 22

The following sentences are included for completeness of this disclosure with reference to the claims.

A software system is disclosed. A one or more computers comprises a one or more input devices, an address space, a processor, a memory and a communication hardware. Said one or more computers comprises said software system. Said one or more computers comprises a first computer and a server. Said software system comprises a device application and a server application. Said server comprises said server application and a system database. Said first computer comprises said device application. Said system database comprises a plurality of user account records, a plurality of animal account records, a one or more event records, a one or more judging records, a plurality of animal competition records, a one or more competition records, a one or more registrant records and an event summary records. Said plurality of user account records is configured to track a plurality of users of said software system. Said plurality of user account records comprises a one or more competitors, a one or more administrators and a one or more judges. Said device application is configured to communicate with said server application on said server. Said server application comprises said plurality of user account records, said plurality of animal account records and said one or more event records. Said one or more event records comprise one or more records related to a one or more events. Said one or more event records comprises said plurality of animal competition records and said one or more registrant records. Said plurality of animal account records comprise one or more records related to a one or more animals tracked in said software system. Said one or more competition records each comprise a record of a competition as between a portion of said one or more animals at one among said one or more event records. Said one or more registrant records comprises said plurality of user account records and said plurality of animal account records. Said one or more registrant records comprise records of users and animals to compete at an event in a one or more competitions.

A software system is disclosed. A one or more computers comprises a one or more input devices, an address space, a processor, a memory and a communication hardware. Said one or more computers comprises said software system. A system database comprises a plurality of user account records, a plurality of animal account records, a one or more event records, a one or more judging records, a plurality of animal competition records, a one or more competition records, a one or more registrant records and an event summary records. Said plurality of user account records comprises a one or more competitors, a one or more administrators and a one or more judges. A server application comprises said plurality of user account records, said plurality of animal account records and said one or more event records. Said one or more event records comprise one or more records related to a one or more events. Said plurality of animal account records comprise one or more records related to a one or more animals tracked in said software system. Said plurality of user account records is configured to track a plurality of users of said software system. Said one or more event records comprises said plurality of animal competition records and said one or more registrant records. Said one or more registrant records comprise records of users and animals to compete at an event in a one or more competitions.

Said one or more registrant records comprises said plurality of user account records and said plurality of animal account records.

Said one or more competition records each comprise a record of a competition as between a portion of said one or more animals at one among said one or more event records.

A device application is configured to communicate with said server application on said server.

A first computer comprises a device application.

A server comprises said server application and said system database.

Said one or more computers comprises a first computer and a server.

Said software system comprises a device application and said server application.

Said software system comprises a check-in procedure and an animal sheet. Said check-in procedure scanning said animal sheet with said device application retrieving a portion of said plurality of user account records related to said first animal retrieving a portion of said competition list related to said first animal and checking in said first animal for a competition.

Said software system comprises a check-in procedure and an animal sheet scanning said animal sheet with said device application retrieving a portion of said plurality of user account records related to said first animal retrieving a portion of said competition list related to said first animal and entering a judging note and rank for said first animal for a competition. Said check-in procedure scanning said animal sheet with said device application retrieving a portion of said plurality of user account records related to said first animal retrieving a portion of said competition list related to said first animal and checking in said first animal for a competition.

Said one or more competitors comprises a one or more animals. Said one or more competitors comprise owners of a portion of said one or more animals having registered said one or more animals in a portion of said competition list in a portion of said one or more event records.

Said one or more administrators comprise a portion of said plurality of users comprising general access to said software system for a portion of said one or more event records in order to organize said one or more event records, said one or more judging records, and said one or more registrant records.

Said one or more judges comprise a portion of said plurality of users responsible for judging a portion of said one or more animals at a portion of said competition list at a portion of said one or more event records.

Said one or more judges are responsible for managing a portion of said one or more judging records. Said one or more judging records comprise a rank field, a reference to a one or more animals, and a reference to a competition.

A software system is disclosed. A check-in procedure scanning a animal sheet with said device application retrieving a portion of said plurality of user account records related to a first animal retrieving a portion of a competition list related to said first animal and checking in said first animal for a competition. A one or more computers comprises a one or more input devices, an address space, a processor, a memory and a communication hardware. Said one or more computers comprises said software system. A system database comprises a plurality of user account records, a plurality of animal account records, a one or more event records, a one or more judging records, a plurality of animal competition records, a one or more competition records, a one or more registrant records and an event summary records. Said plurality of user account records comprises a one or more competitors, a one or more administrators and a one or more judges. A server application comprises said plurality of user account records, said plurality of animal account records and said one or more event records. Said one or more event records comprise one or more records related to a one or more events. Said plurality of animal account records comprise one or more records related to a one or more animals tracked in said software system. Said plurality of user account records is configured to track a plurality of users of said software system. Said one or more event records comprises said plurality of animal competition records and said one or more registrant records. Said one or more registrant records comprise records of users and animals to compete at an event in a one or more competitions.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A software system, wherein:
a one or more computers comprises a one or more input devices, an address space, a processor, a memory and a communication hardware;
said one or more computers comprises said software system;
said one or more computers comprises a first computer and a server;
said software system comprises a device application and a server application;
said server comprises said server application and a system database;
said first computer comprises said device application;
said system database comprises a plurality of user account records, a plurality of animal account records, a one or more event records, a one or more judging records, a plurality of animal competition records, a one or more competition records, a one or more registrant records and an event summary records;
said plurality of user account records is configured to track a plurality of users of said software system;
said plurality of user account records comprises a one or more competitors, a one or more administrators and a one or more judges;
said device application is configured to communicate with said server application on said server;
said server application comprises said plurality of user account records, said plurality of animal account records and said one or more event records;
said one or more event records comprise one or more records related to a one or more events;
said one or more event records comprises said plurality of animal competition records and said one or more registrant records;
said plurality of animal account records comprise one or more records related to a one or more animals tracked in said software system;
said one or more competition records each comprise a record of a competition as between a portion of said one or more animals at one among said one or more event records;
said one or more registrant records comprises said plurality of user account records and said plurality of animal account records; and
said one or more registrant records comprise records of users and animals to compete at an event in a one or more competitions.

2. A software system, wherein:
a one or more computers comprises a one or more input devices, an address space, a processor, a memory and a communication hardware;
said one or more computers comprises said software system;
a system database comprises a plurality of user account records, a plurality of animal account records, a one or more event records, a one or more judging records, a plurality of animal competition records, a one or more competition records, a one or more registrant records and an event summary records;
said plurality of user account records comprises a one or more competitors, a one or more administrators and a one or more judges;
a server application comprises said plurality of user account records, said plurality of animal account records and said one or more event records;
said one or more event records comprise one or more records related to a one or more events;
said plurality of animal account records comprise one or more records related to a one or more animals tracked in said software system;
said plurality of user account records is configured to track a plurality of users of said software system;
said one or more event records comprises said plurality of animal competition records and said one or more registrant records; and
said one or more registrant records comprise records of users and animals to compete at an event in a one or more competitions.

3. The software system of claim 2 wherein:
said one or more registrant records comprises said plurality of user account records and said plurality of animal account records.

4. The software system of claim 2 wherein:
said one or more competition records each comprise a record of a competition as between a portion of said one or more animals at one among said one or more event records.

5. The software system of claim 2 wherein:
a device application is configured to communicate with said server application on said server.

6. The software system of claim 2 wherein:
a first computer comprises a device application.

7. The software system of claim 2 wherein:
a server comprises said server application and said system database.

8. The software system of claim 2 wherein:
said one or more computers comprises a first computer and a server.

9. The software system of claim 2 wherein:
said software system comprises a device application and said server application.

10. The software system of claim 2 wherein:
said software system comprises a check-in procedure and an animal sheet; and
said check-in procedure scanning said animal sheet with said device application retrieving a portion of said plurality of user account records related to said first animal retrieving a portion of said competition list related to said first animal and checking in said first animal for a competition.

11. The software system of claim 2 wherein:
said software system comprises a check-in procedure and an animal sheet scanning said animal sheet with said device application retrieving a portion of said plurality of user account records related to said first animal retrieving a portion of said competition list related to said first animal and entering a judging note and rank for said first animal for a competition; and
said check-in procedure scanning said animal sheet with said device application retrieving a portion of said plurality of user account records related to said first animal retrieving a portion of said competition list related to said first animal and checking in said first animal for a competition.

12. The software system of claim 2 wherein:
said one or more competitors comprises a one or more animals; and
said one or more competitors comprise owners of a portion of said one or more animals having registered said one or more animals in a portion of said competition list in a portion of said one or more event records.

13. The software system of claim 2 wherein:
said one or more administrators comprise a portion of said plurality of users comprising general access to said software system for a portion of said one or more event records in order to organize said one or more event records, said one or more judging records, and said one or more registrant records.

14. The software system of claim 2 wherein:
said one or more judges comprise a portion of said plurality of users responsible for judging a portion of said one or more animals at a portion of said competition list at a portion of said one or more event records.

15. The software system of claim 14 wherein:
said one or more judges are responsible for managing a portion of said one or more judging records; and
said one or more judging records comprise a rank field, a reference to a one or more animals, and a reference to a competition.

16. A software system, wherein:
a check-in procedure scanning a animal sheet with said device application retrieving a portion of said plurality of user account records related to a first animal retrieving a portion of a competition list related to said first animal and checking in said first animal for a competition;
a one or more computers comprises a one or more input devices, an address space, a processor, a memory and a communication hardware;
said one or more computers comprises said software system;
a system database comprises a plurality of user account records, a plurality of animal account records, a one or more event records, a one or more judging records, a plurality of animal competition records, a one or more competition records, a one or more registrant records and an event summary records;
said plurality of user account records comprises a one or more competitors, a one or more administrators and a one or more judges;
a server application comprises said plurality of user account records, said plurality of animal account records and said one or more event records;
said one or more event records comprise one or more records related to a one or more events;
said plurality of animal account records comprise one or more records related to a one or more animals tracked in said software system;
said plurality of user account records is configured to track a plurality of users of said software system;
said one or more event records comprises said plurality of animal competition records and said one or more registrant records; and
said one or more registrant records comprise records of users and animals to compete at an event in a one or more competitions.
